(19) United States
(12) Patent Application Publication
(10) Pub. No.: US 2018/0096320 A1
(43) Pub. Date: Apr. 5, 2018

(54) ACCOUNT TOP-UP FEATURE TO INTERFACE WITH A VENDOR APPLICATION PROGRAMMING INTERFACE

(71) Applicant: PAYPAL, INC., San Jose, CA (US)

(72) Inventors: Eric Yu, Los Gatos, CA (US); Alex Gong, San Jose, CA (US)

(21) Appl. No.: 15/284,356

(22) Filed: Oct. 3, 2016

(51) Int. Cl. G06Q 20/10; G06Q 20/32; H04L 29/06

(52) U.S. Cl. CPC G06Q 20/102; H04L 63/08; G06Q 20/3221

(57) ABSTRACT

There are provided systems and methods for an account top-up feature to interface with a vendor application programming interface (API). A user may utilize a communication device while shopping or otherwise performing transaction processing, where the user may require additional funds to be deposited within an account of the user for transaction processing with a service provider. Generally, the user may provide financial instruments in the account, or preload money to the account, for example, at a terminal, website, or financial processing location. However, the user may include utilize an account top-up feature available on a microsite of the service provider to access an API and one or more processes of a vendor, such as a telecommunication carrier or banking institution, where the user may request various price points to add funds immediately to the account. The service provider may then deposit funds from the vendor to the account.

### TECHNICAL FIELD

The present application generally relates to service provider network interactions with vendor and carrier services, and more specifically to an account top-up feature to interface with a vendor application programming interface (API).

### BACKGROUND

Various types of service providers may provide processing services to users, for example, to engage in transaction with other users and merchants and process such transactions. In this regard, the service providers may provide account services, where a user may establish an account with the service provider and fund the account using one or more financial resources, including stored payment cards and/or bank accounts, as well as deposits of funding or other values to the account. Thus, when the user engages in a transaction with another entity, the user may utilize the account to provide a payment to the other entity using value available from the account, such as charging a payment card, withdrawing funds from a bank account, and/or transferring stored value to the account. However, such conventional funding sources may have limited funds for the user to transfer, which may result in the user having insufficient funds to make a desired payment or purchase.

Therefore, a need exists for the capability of a user to fund an account with unconventional funding sources.

### BRIEF DESCRIPTION OF THE DRAWINGS

FIG. 1 is a block diagram of a networked system suitable for implementing the processes described herein, according to an embodiment;

FIG. 2A is an exemplary interface of a communication device for selecting a price point value to add to an account of the user, according to an embodiment;

FIG. 2B is an exemplary interface of a communication device for entering a phone number with a telecommunication carrier to add value available from the telecommunication carrier to an account, according to an embodiment;

FIG. 2C is an exemplary interface of a communication device to enter authentication credentials for two factor authentication, according to an embodiment;

FIG. 2D is an exemplary interface of a communication device to receive notification of deposited value from a vendor into an account of the user, according to an embodiment;

FIG. 3 is an exemplary flowchart for requesting value to be added to an account with a service provider from a vendor, according to an embodiment;

FIG. 4 is a flowchart of an exemplary process for an account top-up feature to interface with a vendor application programming interface (API), according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for an account top-up feature to interface with a vendor application programming interface (API). Systems suitable for practicing methods of the present disclosure are also provided.

According to various embodiments, a user may want to add value to an account that the user has with a service provider, such as a transaction processor service. The value may correspond to funds that are to be made available in the account for use in transaction processing, such as a payment to a merchant or another user for a transaction. However, in other embodiments, the value may correspond to other values that may be added to an account, including purchased discounts or incentives, data usage for a telecommunication account (e.g., voice minutes, text amounts, and/or data transfer speeds or amounts (e.g., bandwidth speeds or available data amounts to transfer between devices)), a utility service account (e.g., energy credits), merchant specific values (e.g., prepaid merchant value amounts), and/or pre-purchased services. For example, a user may utilize credits, stored value, purchasable value, and/or transferrable value generated by the user that is available with multiple different types of service providers. Such value may include value available from previous work of the user and/or value generated by the user, including paid or unpaid value to the user for work performed by the user and/or an objected associated with the user (e.g., a processing server, solar panel or other type of energy generating device, shared mobile device usage, etc.). Thus, the user may have value with various service providers, merchants, businesses, or other entities created by the user or available for the user for purchase. The entities may store the value of the user, for example, from previously performed work or provided compensation, or may allow the user to perform some task, work, or provide some compensation in order to have value with the entity. Thus, the user may be required to repay the entity for value that the user wishes to transfer to an account. The user may utilize the service provider to process an addition of value to the account from another vendor, such as a banking institution, telecommunication carrier, partner of the service provider that provides gift card processing, or other type of vendor where the user may purchase items and/or provide payment to for the value to be added to the account. For example, instead of adding value to the account by tendering a payment through a financial instrument to the service provider, the user may instead request that the service provider retrieve value from the vendor and add the value to the user's account.

In this regard, the user may utilize a communication device having an application that allows their communication device to access the service provider to request a value transfer from the vendor to the account of the user. The communication device may access an application or website, such as a microsite (e.g., a single webpage or small group of webpages from a main website that have its own links and/or processes), of the service provider, where the microsite may allow for querying an transaction processing or payments application programming interface (API) of the vendor for processing of a value provided to the service provider. In various embodiments, the user may be required to on-board to the microsite, for example, by enrolling in services to add value to the user's account from a vendor, and may be requested to add authentication credentials and/or perform two factor authentication or other authentication means to authenticate the user on the microsite. Once a request to add value is received by the service provider through the microsite, the microsite may request for available price point options from the vendor to add value to the account. For example, the vendor may allow for $5, $10, and $15 deposits from the vendor to the account of the user with the service provider. The price point options may also have an associated fee for the deposit of the value, which may be added by the service provider and/or vendor, and may be a flat rate, variable based on the deposit, or otherwise calculated. Additionally, as the microsite may query continuously or at certain intervals the API of the vendor, the price points may be provided dynamically, including any fees, and vary from user to user and even for the same user at different times.

The user may then select a price point option to add a corresponding value to the account of the user. For example, the user may select to add $10 to their account from the vendor by depositing funding from the vendor to the account of the user. The microsite may then interface with a vendor hosted payment solution, such as a vendor transaction processing process, that may be used to retrieve a payment flow and/or experience for the vendor that requests the vendor to deposit a value corresponding to the selected price point to the account of the user. For example, the payment flow and/or experience may correspond to a transaction processing and/or checkout flow for the vendor where the user authenticates their identity and/or provides additional information necessary to effectuate the deposit of the value from the vendor to the account of the user. The vendor payment flow and/or experience may be provided to the user directly or through the microsite. The flow/experience may be provided through the interfaces and processes of the microsite and/or an application executing on the device of the user, for example, by incorporating the flow/experience into the microsite/application or passing through the microsite. The user may then complete the flow/experience as passed through the microsite, which may then cause the transaction to be processed by the vendor.

The funding of the value may occur from an account of the user with the vendor, such as a telecommunication usage account for a landline or mobile phone, a bank account from a banking institution, and/or an available gift card balance from a gift card that may be processed by a partner of the service provider. Thus, the user may transfer a balance available with the vendor to the account of the user with the service provider. Any additional fees may be either added to the amount charged to the account or deducted from the value transferred to the account of the user with the service provider. In other embodiments, the account or financial instrument of the user with the vendor may be charged for the transfer of the value to the service provider. The vendor hosted payment solution may then interact with the microsite for provision of the value to the account for the user. For example, once the transaction for the value is processed by the vendor using the vendor hosted payment solution, the microsite may request to the vendor transaction processing or payment API to transfer the value to the service provider. For example, the vendor API may interface with an adaptive payments API of the service provider that receives and processes values from the vendor hosted payment solution. The vendor API may provide the value to the adaptive payments API of the service provider. The adaptive payments API may then provide payment to the service provider, for example, to an account of the user. The adaptive payments API may also respond to the vendor API, which in turn may provide a message of the value transfer to the microsite, which may be viewable by the user on the communication device.

In various embodiments, the value received by the adaptive payments API may be deposited to an omnibus account instead of the user's account, where accounting for the user's account may credit the user's account for the value. The value may be transferred to the user's account from the omnibus account, where the user is alerted when the value arrives in the user's account. Additionally, when utilizing the user's telecommunication account with a telecommunication carrier to transfer value to the user's account with the service provider, the user may perform additional authentication during the carrier's payment/checkout flow process through transmission of a code to the user's device and entry to the process. In various embodiments, the service provider may cap the value transfer amount, which may be dependent on the vendor and maximum value transfers for the vendor. Additionally, the value transfers and payouts may be locked so that reversal of funding to the vendor may not be possible.

Thus, users may wish to engage in electronic transaction processing with one or more other entities using value in an account, such as merchants, businesses, or other commercial or governmental agencies. For example, a user may wish to provide a payment to a merchant for a transaction, such as a purchase of one or more items, a bill payment, or other type of required payment or transfer of money by the user to the merchant Various service providers may provide transaction processing services that may allow two or more entities (e.g., personal users, groups of users, merchants, etc.) to engage in electronic processing for a transaction. For example, a payment provider service may offer transaction processing services that provide transfers, payment services, reimbursement or refund services, and other type of financial services. These service providers may further provide additional types of services, including account services and digital wallet service, for example, to store one or more financial instruments of the user for use in transaction processing and provide a digital wallet that may be utilized to perform transaction processing through tokenized payment services.

Thus, the user and/or the merchant may further be required to establish the aforementioned accounts with the service provider in order to engage in transaction processing. The user and/or the merchant may be required to provide personal, business, or other identification information to establish the account, such as a name, address, Employer Identification Number (EIN), and/or other information. The user and/or the merchant may also be required to provide financial information, including payment cards (e.g., credit/debit cards), bank account information, gift cards, and/or benefits/incentives, which may be utilized to provide payments or otherwise engage in processing of another transaction. However, and as described herein, value may also be provided in the account through transfer of value from an outside vendor, such as a telecommunication carrier, utility company, partner for gift card processing, and/or bank. In order to create an account, the user and/or the merchant may be required to select an account name and/or provide authentication credentials, such as a password, personal identification number (PIN), security questions, and/or other authentication information. The service provider may utilize such information to create the account for the user, and provide the user with a digital wallet to the user that allows for electronic transaction processing. The digital wallet may store the user's financial instruments of the user and/or received value from a deposit/transfer from a vendor. In this regard, the service provider may provide a digital token, such as a data package, that represents the digital wallet and may approve the digital wallet for processing of a transaction with the service provider to a device that receives the token. Thus, the token may include data identifying the digital wallet (e.g., a token), as well as authentication information including an identifier for user of the digital wallet, which may be encrypted.

Once an account is created, the account may be accessed through a web browser from a website of the service provider and/or a dedicated application of the service provider, such as a mobile smart phone application. The user and/or the merchant may engage in transaction processing through accessing their respective account and providing transaction information for the transaction. Thus, the aforementioned token may be issued to the user and/or the merchant for their respective accounts, where the token may include data (which may be encrypted) allowing the service provider to identify the user and/or the merchant and their account, as well as authenticate the user and/or the merchant. As such, the token may be transmitted to other entities during transaction processing, which may allow the service identify and authenticate the user's and/or the merchant's account and engage in transaction processing. When the service provider receives the token with transaction information, a transaction may be processed, which may provide payment using the digital wallet, for example, through a financial instrument in the digital wallet and/or value stored to the digital wallet (e.g., deposited value, which may include value transferred/deposited from a vendor).

In this regard, a computing device for a user and/or a merchant, such as a communication device of a user or a merchant point-of-sale device of a merchant, may further include a mobile payment application or more generally a transaction processing application, which may be configured to send and receive payments to another party, such as another user and/or a merchant, or otherwise engage in transaction processing. In various embodiments, a website may provide the transaction processing services, and thus may be accessed by a web browser application. The application (or website) may be associated with a payment provider, such as PayPal® or other online payment provider service, which may provide payments and the other aforementioned transaction processing services on behalf of user, merchants, and other entities. The application may execute on the computing device for a user or a merchant, and may provide various functionalities and processes to the user and/or merchant. For example, a user may utilize the application to send and/or receive payments between the user and another user/merchant for one or more items purchased in a transaction. The merchant may similarly send and/or receive payments between the merchant and another user/merchant, which may include receiving payment for transactions.

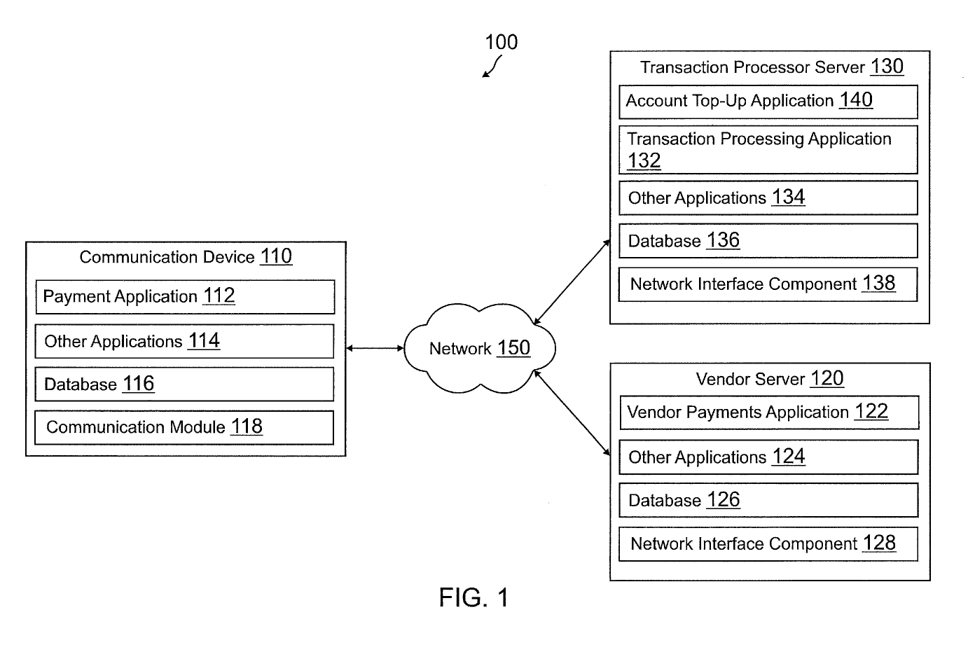

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a communication device 110, a vendor server 120, and a transaction processor server 130 in communication over a network 150. The user (not shown) may utilize communication device 110 to utilize the various features available for communication device 110, which may include processes and/or applications associated with requesting a value from vendor server 120 to be deposited or transferred to an account of the user with transaction processor server 130. In this regard, communication device 110 may be used to access processes of transaction processor server 130 to request the transfer of the value to the user's account, which may correspond to a microsite hosted by transaction processor server 130 or other processes, including loadable interface data and elements for a web browser or dedicated application of communication device 110. Communication device 110 may utilize the processes to communicate the request to vendor server 130, where vendor server 120 interacts with the processes and one or more APIs of transaction processor server 130 to effectuate the transfer to the user's account. Communication device 110 may then be informed of the value deposit in the account, where communication device 110 may then be used for transaction processing using the account.

Communication device 110, vendor server 120, and transaction processor server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Communication device 110 may be implemented as a communication device that may utilize appropriate hardware and software configured for wired and/or wireless communication with vendor server 120, and/or transaction processor server 130. For example, in one embodiment, communication device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

Communication device 110 of FIG. 1 contains a payment application 112, other applications 114, a database 116, and a communication module 118. Payment application 112 and other applications 114 may correspond to executable processes, procedures, and/or applications with associated hardware. In other embodiments, communication device 110 may include additional or different modules having specialized hardware and/or software as required.

Payment application 112 may correspond to one or more processes to execute software modules and associated devices of communication device 110 to enter one or more payment instruments or other funding sources for storage in a digital wallet associated with a payment account (e.g., stored and/or serviced by transaction processor server 130), request transfer of a value amount into the digital wallet from a vendor, such as vendor server 120, and/or engage in transaction processing with another entity, such as a merchant. In this regard, payment application 112 may correspond to specialized hardware and/or software utilized by a user of communication device 110 that initially provides an interface to permit the user to enter input and other data for payment instruments, for example, through an input device (e.g., touch screen with a graphical user interface, keypad/keyboard, mouse, etc.) and/or through a data capture device (e.g., scanner, camera, other optical device, etc.). Such information may be stored with transaction processor server 130 for use with an online digital wallet stored to an account for the user with transaction processor server 130, which may be utilized for transaction processing with another entity, such as a merchant associated with vendor server 120. In various embodiments, information for the account and/or digital wallet may also be stored to communication device 110 for use in an offline environment. The account accessible through payment application 112 may be used to initiate, receive, and/or process/complete transactions using services provided by transaction processor server 130. Once entered, the payment instruments may be communicated to transaction processor server 130 over network 150 by payment application 112 for establishment and/or maintenance/update of the account and/or entry into the digital wallet for the user. The user of communication device 110 may also enter discounts and/or benefits to payment application 112 for storage to the digital wallet and use during transaction processing.

However, in other embodiments described herein, the user may instead wish to transfer a value, such as a funding amount, into the digital wallet instead of providing payment instruments for use in the digital wallet. For example, the user may wish to provide a limit on an amount for use in the digital wallet to protect from fraud or overuse, or may wish to deposit value into the account from another vendor where the user has an account or currently held value, such as a telecommunication carrier account, bank account, and/or gift card balance. In order to request a transfer or deposit of value from a vendor associated with vendor server 120 to the account of the user associated with communication device 110, payment application 112 may be utilized to receive data for one or more interfaces that may be used to generate the request, for example, by displaying one or more price point selections for a value amount requested by the user, which may further include fees for usage of the transfer/deposit. The interface data may be retrieved from transaction processor server 130, such as through accessing a microsite hosted by transaction processor server 130. The user may select one or more price point options, which may be communicated to vendor server 120 and/or transaction processor server 130 for processing. Additionally, payment application 112 may receive a transaction processing and/or checkout flow to enter data necessary to complete the transaction to have the value added to the account of the user, where the flow may be received from vendor server 120 and/or transaction processor server 130 and presented through payment application 112. The user may then utilize payment application 112 to enter information for the flow, which may confirm the request and cause the transfer/deposit of the value to the user's account. Payment application 112 may further be used to view the results of the processed transaction for the value, for example, confirmation or denial messages of the value transferred/deposited in the account and/or account status/balance.

Payment application 112 may utilize one or more user interfaces, such as graphical user interfaces presented using an output display device of communication device 110, to enable the user associated with communication device 110 to perform transaction processing. In various embodiments, payment application 112 may correspond to a general browser application configured to retrieve, present, and communicate information over the Internet (e.g., utilize resources on the World Wide Web) or a private network. For example, payment application 112 may provide a web browser, which may send and receive information over network 150, including retrieving website information (e.g., a website for transaction processor server 130), presenting the website information to the user, and/or communicating information to the website, such as a location of the user. However, in other embodiments, payment application 112 may include a dedicated application of transaction processor server 130 or other entity (e.g., a merchant), which may be configured to assist in processing transactions. Payment application 112 may be utilized to select payment instrument(s) for use in providing payment for a purchase transaction, transfer, or other financial process, which may include the stored value transferred/deposited by vendor server 120. As discussed herein payment application 112 may utilize a digital wallet stored to an account with a payment provider, such as transaction processor server 130, for example, through providing a token that identifies the account and authenticates the user for use of the account. Payment application 112 may use such a token during transaction processing to authenticate the user and complete transaction processing by providing the token, which may be encrypted and/or provided through a secure channel to authenticate the user and/or the user's digital wallet to transaction processor server 130 and allow for transaction processing and payment using the user's digital wallet. Payment application 112 may be utilized to view the results of payment, for example, using transaction histories, dispute resolution processes, and other post-transaction process.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking applications. Other applications 114 may also include other location detection applications, which may be used to determine a location for the user, such as a mapping, compass, and/or GPS application, which can include a specialized GPS receiver that obtains location information for communication device 110 and processes the location information to determine a location of communication device 110 and the user. Other applications may include social networking applications, media viewing, and/or merchant applications. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use devices of communication device 110, such as display devices capable of displaying information to users and other output devices, including speakers.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with payment application 112 and/or other applications 114, identifiers associated with hardware of communication device 110, or other appropriate identifiers, such as identifiers used for payment/user/device authentication or identification, which may be communicated as identifying communication device 110 to transaction processor server 130. In various embodiments, account information and/or digital wallet information may be stored to database 116 for use by communication device 110. Additionally, received data necessary to process a request to add value to an account of the user with transaction processor server 130 from vendor server 120 may be stored to database 116.

Communication device 110 includes at least one communication module 118 adapted to communicate with vendor server 120 and/or transaction processor server 130. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices (e.g., vendor server 120) using short range communications, such as Bluetooth Low Energy, LTE Direct, WiFi, radio frequency, infrared, Bluetooth, and near field communications.

Vendor server 120 may be implemented using any appropriate hardware and software configured for wired and/or wireless communication with communication device 110 and/or transaction processor server 130. Thus, vendor server 120 may correspond to a server of an entity that may provide services to the user associated with communication device 110, including telecommunication services, banking services, gift card processing and/or fulfillment services, and/or other types of services that a user may purchase and pay for, and where the user may be able to have as stored or purchasable value. In various embodiments, vendor server 120 may be maintained, for example, by a service provider that offers resources, infrastructure, devices, and/or other technology to effectuate data transfers between users. In this regard, vendor server 120 may correspond to a PSTN provider, or may correspond to Internet Service Providers, communication applications, mobile telecommunication service providers, and/or other types of service providers. However, in other embodiments, vendor server 120 includes one or more processing applications which may be configured to interact with communication device 110 and/or transaction processor server 130 to allow the user associated with communication device 110 to deposit or transfer value from vendor server 120 to an account of the user with transaction processor server 130, such as a partner service of transaction processor server 130 that allows for gift card fulfillment and/or processing or a financial institution that may have stored or available value to the user. Other types of vendors may include businesses that the user works for or will perform work for to receive compensation as stored or available value, other types of services where a user may receive value for work performed by the user or another object/entity associated with the user (e.g., computing processing services, energy storage and/or provision services, etc.), energy services that the user may have pre-purchased credits for use or may have a payable account with, other type of data service providers including cable/satellite television services, other types of living services (e.g., trash, sewage, water, etc.), or any other type of vendor where a user may provide some monetary or other compensation for stored credit and/or purchasable credit. Although a server is shown, the server may be managed or controlled by any suitable processing device. Although only a single service provider is shown, a plurality of service providers may function similarly.

Vendor server 120 of FIG. 1 contains a vendor payments application 122, other applications 124, a database 126, and a network interface component 128. Vendor payments application 122 and other applications 124 may correspond to processes, procedures, and/or applications executable by a hardware processor, for example, a software program. In other embodiments, vendor server 120 may include additional or different modules having specialized hardware and/or software as required.

Vendor payments application 122 may correspond to one or more processes to execute software modules and associated specialized hardware of vendor server 120 to provide value to an account with transaction processor server 130 for the user associated with communication device 110. In this regard, vendor payments application 122 may correspond to specialized hardware and/or software of vendor server 120 to provide a transaction processing or payment API that may be accessible by a microsite or process associated with transaction processor server 130 to provide data on price point options for values that may be added to the account to communication device 110. Thus, the API may be accessible and provide data, which may be served dynamically based on changing price points, values, and/or fees. The data may be provided back to the microsite or the process, which may load the data to an interface of communication device 110. Once the user selects a price point option having a corresponding value for transfer/deposit to the user's account with transaction processor server 130, vendor payments application 122 may provide a vendor hosted payment solution, such as a vendor transaction processing process, that may receive the request for the value to be added to the user's account. The vendor hosted payment solution may respond with a checkout flow or experience for vendor server 120 to authenticate the user, validate the request, and/or confirm the value transfer/deposit to the user's account. The flow may request various user information, include authentication credentials, a phone number for two factor authentication, and/or other required data to complete the transaction to have the value added to the user's account with transaction processor server 130. The vendor hosted payment solution may respond to the microsite or process confirming the transaction, where the microsite/process may request the value from the transaction processing or payment API. The transaction processing or payment API may respond to an adaptive payments API of transaction processor server 130 to provide the value, which may be transferred from vendor server 120 to transaction processor server 130 through the adaptive payments API. The adaptive payments API may then resolve the value deposit into the account of the user, where the transaction processing or payment API of vendor payments application 122 may receive a response message from the adaptive payments API that confirms the deposit, and the transaction processing or payment API may the provide a response to the microsite or process of the value added to the user's account.

Vendor payments application 122 may include various processes that allow a user to establish and/or maintain value with vendor server 120. For example, vendor payments application 122 may provide for processes utilized by a bank or other financial institution that may store value, such as funds, for a user or provide the value, for example, through extendible credit. In such embodiments, vendor server 120 may instead correspond to a server associated with a financial institution, such as a bank. Thus, vendor server 120 may provide the value transferred/deposited to the user's account from an account held by the user with vendor server 120. However, in other embodiments, vendor server 120 may correspond to a partner of transaction processor server 130 that may provide for establishment, processing, and/or fulfillment of gift cards, such as preloaded or prefunded payment cards usable in general or specific situations. In such embodiments, vendor payments application 122 may process a received gift card to provide the value to the user's account.

In further embodiments, vendor payments application 122 may provide data transfer services, including voice, text, and/or other data transfers and telecommunication and data usage account services. In this regard, vendor payments application 122 may establish a telecommunication usage account for one or more users, for example, a telecommunication account for a user associated with communication device 110 The telecommunication account may correspond to an account allowing a user to perform data transfers with other users, such as voice calls, messaging, and/or other types of data transfers. The telecommunication account may be pre-paid and include a number of minutes, messages, and/or bandwidth usage allowance. However, the telecommunication account may include a set monthly amount with allowance for overages and be billable monthly or for another time period/interval. The telecommunication account may also correspond to a straight bill for data usage within a time period and/or one use. The telecommunication account may be associated with a user and/or a communication device. Thus, the telecommunication account may be used with more than one user using a single communication device (e.g., a telephone in a family household) or may be used with multiple communication devices (e.g., a family plan for multiple mobile phones). The user associated with communication device 110 may request that value be deducted from (e.g., transferred out of) the telecommunication account to the user's account with transaction processor server 130. In other embodiments, the user may authorize a charge for the value to the telecommunication account, which may be resolved on a later bill for the telecommunication account. Payment for the bill may be retrieved by vendor server 120 from the user through the aforementioned billing mechanisms, including deductions of funds and/or other stored values from the telecommunication account.

Vendor server 120 includes other applications 124 as may be desired in particular embodiments to provide features to vendor server 120. For example, other applications 124 may include security applications for implementing server-side security features, programmatic client applications for interfacing with appropriate application programming interfaces (APIs) over network 150, or other types of applications. In various embodiments, other applications 124 may include financial applications, such as banking, online payments, money transfer, or other applications associated with transaction processor server 130. Other applications 124 may contain software programs, executable by a processor, including a graphical user interface (GUI) configured to provide an interface to the user. Other application 124 may further provide applications to process, store, and/or provide value to a user's account with transaction processor server 130.

Vendor server 120 may further include database 126 which may include, for example, identifiers such as operating system registry entries, cookies associated with vendor payments application 122 and/or other applications 124, identifiers associated with hardware of vendor server 120, or other appropriate identifiers, such as identifiers used for payment/user/device authentication or identification. Identifiers in database 126 may be used by a payment/credit provider, such as transaction processor server 130, to associate vendor server 120 with a particular account maintained by the payment/credit provider. Database 126 may further include value stored or available for purchase with vendor server 120, including price points for value transfers to transaction processor server 130 and received requests to transfer value.

Vendor server 120 includes at least one network interface component 128 adapted to communicate with communication device 110 and/or transaction processor server 130. In various embodiments, network interface component 128 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Transaction processor server 130 may be maintained, for example, by an online service provider, which may provide transaction processing and payment services, including value transfer services from other entities to an account with transaction processor server 130. In this regard, transaction processor server 130 includes one or more processing applications which may be configured to interact with communication device 110, vendor server 120, and/or another device/server to facilitate processing a transaction when communication device 110 does not have network connectivity by preloading a token preauthorized for a predicted amount required by the user. In one example, transaction processor server 130 may be provided by PAYPAL®, Inc. of San Jose, Calif., USA. However, in other embodiments, transaction processor server 130 may be maintained by or include another type of service provider, which may provide connection services to a plurality of users.

Transaction processor server 130 of FIG. 1 includes an account top-up application 140, a transaction processing application 132, other applications 134, a database 136, and a network interface component 138. Transaction processing application 132 and other applications 134 may correspond to executable processes, procedures, and/or applications with associated hardware. In other embodiments, transaction processor server 130 may include additional or different modules having specialized hardware and/or software as required.

Account top-up application 140 may correspond to one or more processes to execute software modules and associated specialized hardware of transaction processor server 130 to process value transfers from vendor server 120 to an account with transaction processor server 130 for a user associated with communication device 110. In this regard, account top-up application 140 may correspond to specialized hardware and/or software to receive a request for a value transfer from vendor server 120 to the account of the user with transaction processor server 130. Account top-up application 140 may provide one or more microsites, which may correspond to a subset of a website provided by transaction processor server 130, that connects to one or more APIs and/or processes of vendor server 120 to receive price point data for one or more price point options to add value to an account of the user with transaction processor server 130. For example, the microsite provided by account top-up application 140 may access a transaction processing or payments API provided by vendor server 120 that allows the microsite to retrieve the price point data. The microsite may then provide the data to communication device 110 for display to the user. In other embodiments, account top-up application 140 may utilize one or more executable processes instead to retrieve the price point data and provide the price point data to communication device 110, for example, through one or more application interfaces.

In various embodiments, when accessing the microsite, the user may be required to enter authentication credentials, for example, by logging in to transaction processor server 130 through authentication credentials for the user's account with transaction processor server 130. In embodiments where the user has not yet on-boarded or signed up for the process to transfer value from vendor server 120 to transaction processor server 130, the user may be required to establish an account and/or agree to allow for value transfers into the account from outside vendors. For example, the user may be required to provide authentication credentials, enroll in an account, and/or agree to terms associated with value transfers/deposits. Once the user has been properly authenticated, the user may then receive the price point options displayed through one or more interfaces of communication device 110. Once the user selects a price point option, the microsite/process may communicate with vendor server 120 to receive a checkout flow/experience from a vendor hosted payment solution of vendor server 120, as discussed herein. The microsite/process may then output the flow on communication device 110 to request the value addition from vendor server 120 to an account of the user with transaction processor server 130. For example, the flow may be output through one or more interfaces provided by the microsite/process, or interface and flow data and processes for the flow with vendor server 120 may be communicated to communication device 110. Vendor server 120 may then process received transaction data for the value, as discussed herein.

Account top-up application 140 may further provide an adaptive payments API that may be used to process data for received values from vendor server 120 and effectuate a transfer/deposit to the user's account with transaction processor server 130. For example, the adaptive payments API may interface with the transaction processing or payments API to receive data for the value addition. The adaptive payments API may request deposit to the user's account, such as a value transfer request to the account, or a value transfer request first an omnibus account and value transfer from the omnibus account to the user's account. The adaptive payments API may then respond once the value transfer is effectuated to the transaction processing or payments API, which may then provide data back to the microsite of the value transfer. The microsite may the provide communication device 110 with information about the value transfer/deposit, such as account information and/or balance.

Transaction processing application 132 may correspond to one or more processes to execute software modules and associated specialized hardware of transaction processor server 130 to provide payment services to merchants and users, for example though an account and/or payment instruments of the user and/or merchant stored in a digital wallet of the account. In this regard, transaction processing application 132 may correspond to specialized hardware and/or software to establish one or more accounts, including digital wallets storing payment instruments. The services may allow for a payment to the merchant by a user through a payment instrument, including a credit/debit card, banking account, payment account with transaction processor server 130, and/or other financial instrument. Payment may also be effectuated through stored value, such as value transferred from vendor server 120 and deposited to an account for the user. In order to establish an account for a merchant and/or user to send and receive payments, transaction processing application 132 may receive information requesting establishment of the payment account. The information may include user personal, business, and/or financial information. Additionally the information may include a login, account name, password, PIN, or other account creation information. The merchant/user may provide a name, address, social security number, or other personal or business information necessary to establish the account and/or effectuate payments through the account. Transaction processing application 132 may further allow the merchant/user to service and maintain the payment account, for example, by adding and removing payment instruments.

Transaction processing application 132 may be used to provide a payment for a transaction to a merchant, for example, using communication device 110. For example, communication device 110 may receive a token and store the token for later use. Thus, when communication device 110 wishes to provide payment for a transaction, communication device 110 may provide the token to a merchant or other user. The merchant/user may the process the transaction with transaction processing application 132 using the token by providing the token and transaction information to transaction processing application 132. Transaction processing application 132 may utilize data in the token to debit an account of the user and provide the payment to an account of the merchant/user. Transaction processing application 132 may also be used to provide transaction histories for processed transactions.

In various embodiments, transaction processor server 130 includes other applications 134 as may be desired in particular embodiments to provide features to transaction processor server 130. For example, other applications 134 may include security applications for implementing server-side security features, programmatic client applications for interfacing with appropriate application programming interfaces (APIs) over network 150, or other types of applications. Other applications 134 may contain software programs, executable by a processor, including a graphical user interface (GUI), configured to provide an interface to the user when accessing transaction processor server 130, where the user or other users may interact with the GUI to more easily view and communicate information. In various embodiments, other applications 134 may include connection and/or communication applications, which may be utilized to communicate information to over network 150.

Additionally, transaction processor server 130 includes database 136. As previously discussed, the user and/or the merchant may establish one or more digital wallets and/or accounts with transaction processor server 130. Digital wallets and/or accounts in database 136 may include user information, such as name, address, birthdate, payment instruments/funding sources, additional user financial information, user preferences, and/or other desired user data. Users may link to their respective digital wallets and/or payment accounts through an account, user, merchant, and/or device identifier. Thus, when an identifier is transmitted to transaction processor server 130, e.g., from communication device 110, one or more digital wallets and/or payment accounts belonging to the users may be found. Database 136 may also store received price point data, as well as data received for a value transfer.

In various embodiments, transaction processor server 130 includes at least one network interface component 138 adapted to communicate communication device 110 and/or vendor server 120 over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

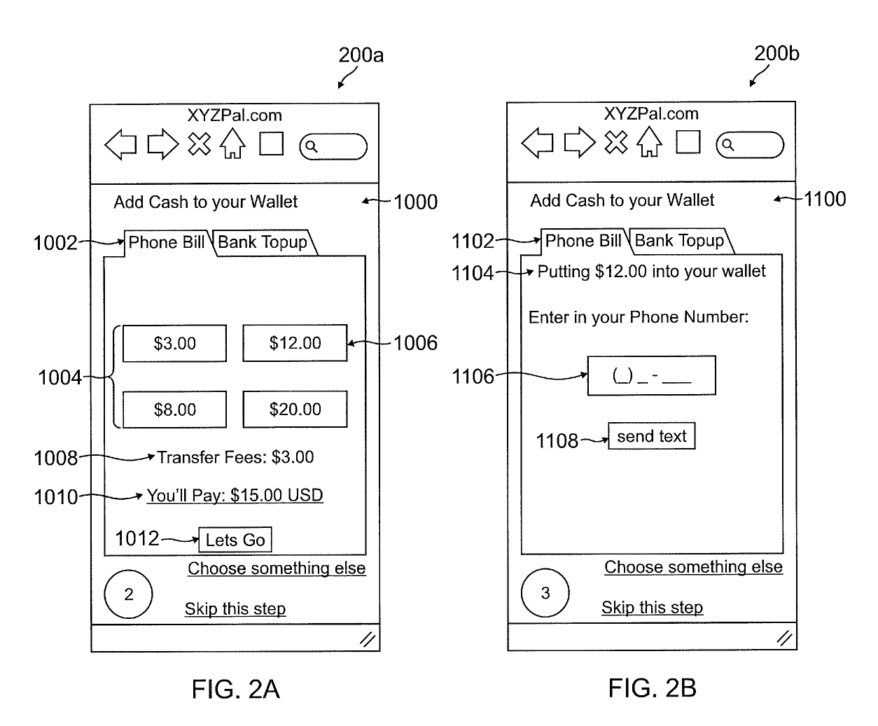

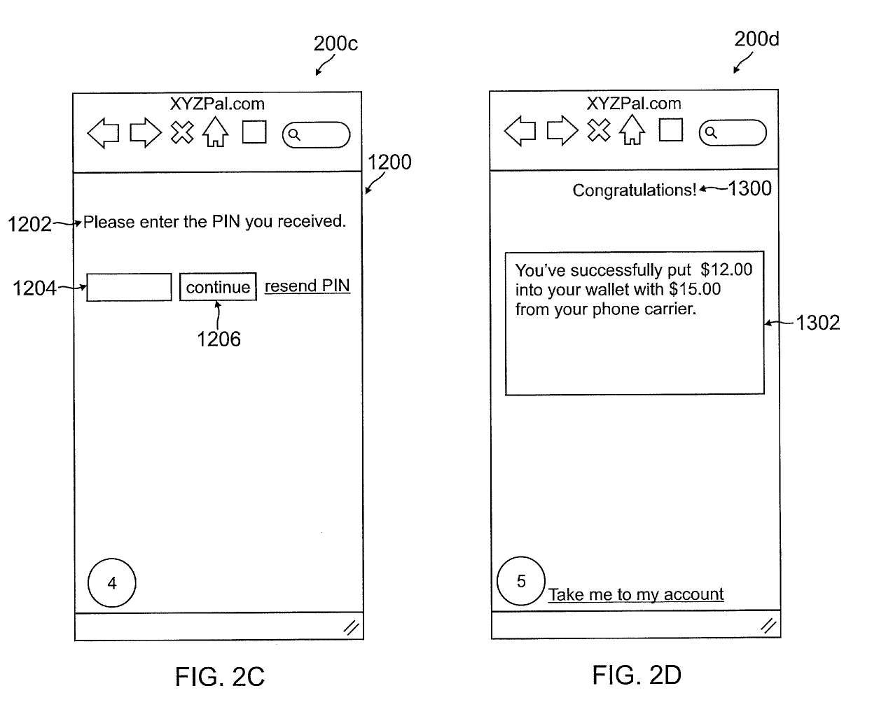

FIG. 2A is an exemplary interface of a communication device for selecting a price point value to add to an account of the user, according to an embodiment. Environment 200a of FIG. 2A includes an interface 1000 of a communication device corresponding generally to the described features, processes, and components of communication device 110 in environment 100 of FIG. 1. In this regard, a user utilizing a communication device may view interface 1000, where interface 1000 may provide options for performing a value addition to an account of a user with a service provider from a vendor different than the service provider, such as a telecommunication carrier, utility company, banking institution, and/or partner gift card processor of the service provider.

For example, interface 1000 in environment 200a includes a phone bill tab 1002 of a value addition process, where phone bill tab 1002 allows a user to add value to the user's account with the service provider using a phone bill of the user with the vendor. Phone bill tab 1002 includes price point options 1004 corresponding to various values the user may add from the vendor, such as $3.00, $8.00, $12.00, and $20.00. As shown in environment 200a, selected price point option 1006 corresponds to $12.00. Additionally, the user is informed of a fee 1008 of $3.00 in phone bill tab 1002. Thus, a total 1010 is shown of $15.00. If the user wishes to continue, the user may select a request option 1012 within phone bill tab 1002.

FIG. 2B is an exemplary interface of a communication device for entering a phone number with a telecommunication carrier to add value available from the telecommunication carrier to an account, according to an embodiment. Environment 200b of FIG. 2B includes an interface 1100 of a communication device corresponding generally to the described features, processes, and components of communication device 110 in environment 100 of FIG. 1. In this regard, a user utilizing a communication device may view interface 1100, where interface 1100 may provide a checkout flow of a vendor to enter information necessary to transfer or deposit value from the vendor to an account of the user with a service provider.

For example, interface 1100 displays data retrieved from the vendor for the checkout flow to add value to the user's account with the service provider that is different from the vendor. Thus, a phone bill tab 1102 in environment 200b displays a value to be added to the user's account (e.g., for availability and use in the user's digital wallet). The user may add a phone number is field 1106, where the user may then select request text 1108 to perform authentication through a sent code. The user may utilize the checkout flow in phone bill tab 1102 to then process a transaction for the value.

FIG. 2C is an exemplary interface of a communication device to enter authentication credentials for two factor authentication, according to an embodiment. Environment 200c of FIG. 2C includes an interface 1200 of a communication device corresponding generally to the described features, processes, and components of communication device 110 in environment 100 of FIG. 1. In this regard, a user utilizing a communication device may view interface 1200, where interface 1200 may provide additional interfaces of a checkout flow of a vendor to enter information necessary to transfer or deposit value from the vendor to an account of the user with a service provider. For example, interface 1200 includes a request 1202 to enter information provided to the user, such as a code transmitted to the user through a text. The code may be entered to field 1204, where the user may then select a submit option 1206 to provide the code back to a vendor to authenticate the user and request that the vendor transfer a value to an account of the user with an external service provider.

FIG. 2D is an exemplary interface of a communication device to receive notification of deposited value from a vendor into an account of the user, according to an embodiment. Environment 200d of FIG. 2D includes an interface 1300 of a communication device corresponding generally to the described features, processes, and components of communication device 110 in environment 100 of FIG. 1. In this regard, a user utilizing a communication device may view interface 1300, where interface 1300 may provide a notification to the user of the results of a transaction to transfer a value from a vendor to an account of the user with a service provider. Thus, notification 1302 informs the user of the value that has been added to the account, for example, $12.00, as well as the terms of the value transfer, such as the total cost with a fee of $15.00.

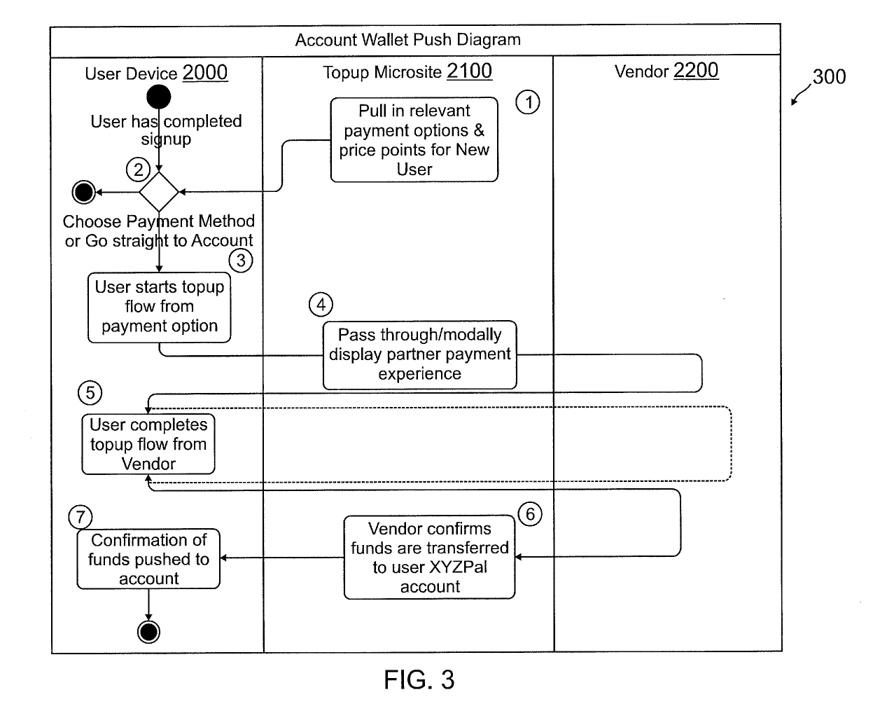

FIG. 3 is an exemplary flowchart for requesting value to be added to an account with a service provider from a vendor, according to an embodiment. FIG. 3 includes user device 2000 and vendor 2200 corresponding generally to the described features, processes, and/or applications of communication device 110 and vendor server 120 discussed in reference to environment 100 of FIG. 1. Moreover, a top-up microsite 2100 may be provided by one or more of the features, processes, and/or applications of transaction processor server 130 discussed in reference to environment 100 of FIG. 1.

In this regard, environment 300 includes an exemplary diagram and flowchart to adding value to an account with a service provider, such as a transaction processor entity associated with top-up microsite 2100, from vendor 2200. Thus, at step 1, after a user has utilized user device 2000 to complete enrollment and/or on-boarding for such transfers, top-up microsite may load relevant payment and price point options for vendor 2200 to user device 2100, for example, after accessing such data from an API of vendor 2200. The user may choose to directly enter their account, which may end the experience at step 2. However, if the user selects a payment method and price point option, at step 3 the user starts a flow to top-up their account by adding value to their account from vendor 2200. Thus, user device 2000 may interface with top-up microsite 2100, at step 4, to receive the checkout flow from vendor 2200 to authorize the value transfer/deposit from vendor 2200 to the user's account. Top-up microsite 2100 may with vendor 2200 to pull the relevant checkout flow and pass through or modally display the payment and checkout interface for the checkout flow from vendor 2200.

Thus, top-up microsite 2100 may provide the checkout flow back to user device 2000 for display to the user. The user may complete the checkout flow by entering required information, at step 5. The user may be required to authenticate their identity, approve the value transfer/deposit from vendor 2200 to the user's account with a service provider, and/or perform additional actions to process a transaction for the value transfer/deposit. Once completed, the information is routed back to vendor 2200 from user device 2000, where vendor 2200 confirms that the value (e.g., funds) are transferred to the user's account, at step 6, with top-up microsite 2100. For example, top-up microsite 2100 may receive approval after one or more APIs of vendor 2200 perform the value transfer (e.g., the fund transfer) with one or more APIs of the service provider. Once top-up microsite 2100 receives the confirmation, at step 7, user device 2000 may receive confirmation of the value added to the user's account, such as funds pushed into the user's account from vendor 2200.

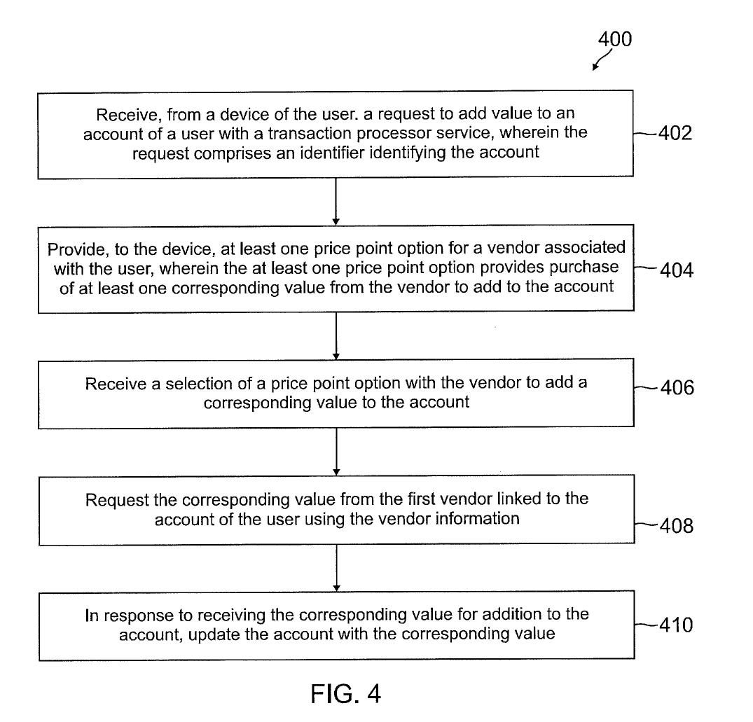

FIG. 4 is a flowchart of an exemplary process for an account top-up feature to interface with a vendor application programming interface (API), according to an embodiment. Note that one or more steps, processes, and methods described herein may be omitted, performed in a different sequence, or combined as desired or appropriate.

At step 402, a request to add value to an account of a user with a transaction processor service is received, from a device of a user, wherein the request comprises an identifier identifying the account. Prior to this, an account value addition interface may be provided to the device through one of a dedicated application of the service provider system or microsite for a website of the service provider system, wherein the account value addition interface comprises an authentication process for the user. Thus, authentication credentials for the authentication process may be received through the account value addition interface.

At least one price point option for a vendor associated with the user is provided to the device, wherein the at least one price point option provides purchase of at least one corresponding value from the vendor to add to the account, at step 404. In various embodiments, a vendor application programming interface (API) for a transaction processing service of the first vendor to request a service or value provided by the first vendor is accessed. The at least one price point option for at least one available service or value provided by the first vendor may be retrieved, and the at least one price point option may be communicated to the device through an interface of an account value addition microsite of a website for the service provider system. In various embodiments, vendor information used to determine the first vendor may further be for a second vendor linked to the account of the user, wherein the at least one price point option is further for the second vendor to purchase the at least one corresponding value from the second vendor. Thus, the at least one price point option may comprise a plurality of price point options each associated with a cost to purchase a value for each of the plurality of price point options from the first vendor and the second vendor

The account value addition interface previously discussed may be provided through a top-up microsite, where the top-up microsite communicates with an application programming interface (API) of the vendor, and wherein the top-up microsite requests the at least one price point option from the carrier payments hosted solution process through the API. At step 406, a selection of a price point option with the vendor to add a corresponding value to the account is received. The corresponding value from the first vendor linked to the account of the user is requested using the vendor information, at step 408. The top-up microsite may further access to a vendor hosted payments solution process provided by the vendor, and wherein the top-up microsite requests the corresponding value from the vendor hosted payments solution process through a checkout flow for the vendor provided by the vendor hosted payments solution process

At step 410, in response to receiving the corresponding value for addition to the account, the account information for the account is updated with the corresponding value. The receiving the selection of the price point option may further comprise receiving the selection of the price point option with the first vendor, wherein the corresponding amount is received from the first vendor. However, in other embodiments, it may be determined that the first vendor cannot process the price point option to provide the corresponding value to the service provider system for the account. Thus, the corresponding value may be requested from the second vendor linked to the account of the user using the vendor information, and the corresponding value may be received from the second vendor. Additionally, an approval to use the second vendor may be requested from the user, and the approval may be received from the user.

In various embodiments, the first vendor provides the corresponding value to the service provider system from a vendor account of the user with the vendor, wherein the vendor account comprises the corresponding value previously stored to the vendor account or added to the vendor account in response to the requesting the corresponding value. Thus, the user may pay the first vendor for the corresponding value, as well as any fees. The first vendor may comprise one of a mobile cellular phone carrier, a utility company, a financial banking institution, or a partner of the service provider that provides gift card processing.

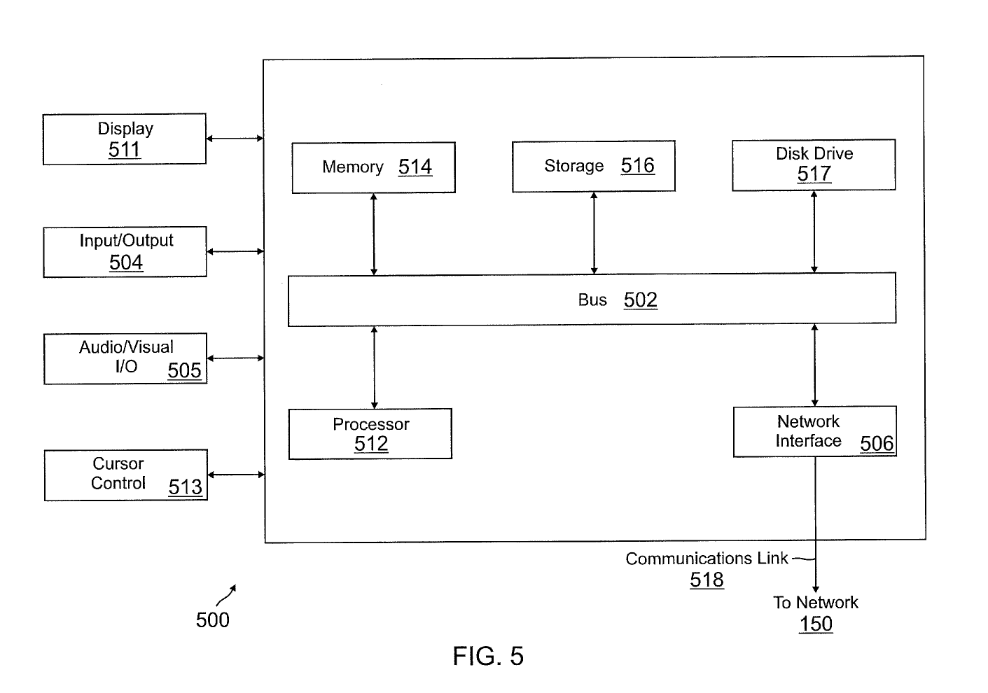

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common fauns of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory storing account information for an account of a user with the service provider system, wherein the account information comprises vendor information for a first vendor linked to the account of the user; and
one or more hardware processors configured to execute instructions to cause the service provider system to perform operations comprising:
receiving, from a device of the user, a request to add value to the account of the user, wherein the request comprises an identifier identifying the account;
providing, to the device, at least one price point option to purchase at least one corresponding value from the first vendor to add to the account using the account information;
receiving a selection of a price point option to add a corresponding value to the account;
requesting the corresponding value from the first vendor linked to the account of the user using the vendor information; and
in response to receiving the corresponding value for addition to the account, updating the account information for the account with the corresponding value.

2. The service provider system of claim 1, wherein the providing the at least one price point option comprises:
accessing a vendor application programming interface (API) for a transaction processing service of the first vendor to request a service or value provided by the first vendor;
retrieving the at least one price point option for at least one available service or value provided by the first vendor; and
communicating the at least one price point option to the device through an interface of an account value addition microsite of a website for the service provider system.

3. The service provider system of claim 1, wherein the vendor information is further for a second vendor linked to the account of the user, and wherein the at least one price point option is further for the second vendor to purchase the at least one corresponding value from the second vendor.

4. The service provider system of claim 3, wherein the at least one price point option comprises a plurality of price point options each associated with a cost to purchase a value for each of the plurality of price point options from the first vendor and the second vendor.

5. The service provider system of claim 3, wherein the receiving the selection of the price point option further comprises receiving the selection of the price point option with the first vendor, wherein the corresponding amount is received from the first vendor.

6. The service provider system of claim 3, wherein the receiving the selection of the price point option further comprises receiving the selection of the price point option with the first vendor, and wherein the operations further comprise:
determining that the first vendor cannot process the price point option to provide the corresponding value to the service provider system for the account; and
requesting the corresponding value from the second vendor linked to the account of the user using the vendor information,
wherein the corresponding amount is receiving from the second vendor.

7. The service provider system of claim 6, wherein the requesting the corresponding value from the second vendor comprises requesting approval of use of the second vendor to receive the corresponding value from the user, and wherein the operations further comprise:
receiving, from the device, the approval of use of the second vendor from the user.

8. The service provider system of claim 1, wherein prior to the receiving the request to add value to the account, the operations further comprise:
providing an account value addition interface to the device through one of a dedicated application of the service provider system or microsite for a website of the service provider system, wherein the account value addition interface comprises an authentication process for the user; and
receiving authentication credentials for the authentication process through the account value addition interface.

9. The service provider system of claim 1, wherein the first vendor provides the corresponding value to the service provider system from a vendor account of the user with the vendor, and wherein the vendor account comprises the corresponding value previously stored to the vendor account or added to the vendor account in response to the requesting the corresponding value.

10. The service provider system of claim 9, wherein the user pays the first vendor for the corresponding value.

11. The service provider system of claim 1, wherein the first vendor comprises one of a mobile cellular phone carrier, a financial banking institution, or a partner of the service provider that provides gift card processing.

12. A method comprising:
receiving, from a device of a user, a request to add value to an account of the user with a transaction processor service, wherein the request comprises an identifier identifying the account;
providing, to the device, at least one price point option for a vendor associated with the user, wherein the at least one price point option provides purchase of at least one corresponding value from the vendor to add to the account;
receiving a selection of a price point option with the vendor to add a corresponding value to the account;
requesting the corresponding value from the vendor;
receiving the corresponding value from the vendor; and
adding the corresponding value to the account.

13. The method of claim 12, wherein prior to the receiving the request, the method further comprises:
providing a top-up micro site for the account to the device, wherein the top-up microsite comprises an authentication process for the user;
receiving authentication credentials for the authentication process through the account value addition interface;
wherein the receiving the request comprises accessing, by the device, the top-up microsite and receiving the credentials, and wherein the at least one price point option is provided through the top-up microsite.

14. The method of claim 13, wherein the top-up micro site communicates with an application programming interface (API) of the vendor, and wherein the top-up microsite requests the at least one price point option from the carrier payments hosted solution process through the API.

15. The method of claim 14, wherein the top-up microsite further accesses to a vendor hosted payments solution process provided by the vendor, and wherein the top-up microsite requests the corresponding value from the vendor hosted payments solution process through a checkout flow for the vendor provided by the vendor hosted payments solution process.

16. The method of claim 12, wherein the corresponding value is received from a telecommunication carrier, a service provider, or a partner of the transaction processor service for gift card processing.

17. A mobile device system comprising:
a non-transitory memory; and
one or more hardware processors coupled to the non-transitory memory and configured to read instructions from the non-transitory memory to cause the mobile device system to perform operations comprising:
retrieving account value addition information from a microsite of a transaction processor service;
providing an account value addition interface from a microsite using the account value addition information, wherein the account value addition interface comprises at least one price point option for a vendor associated with the user, wherein the at least one price point option provides purchase of at least one corresponding value from the vendor to add to an account of the user with the transaction processor service;
receiving a selection of a price point option with the vendor to add a corresponding value to the account;
requesting the corresponding value from the vendor using a vendor payments solution process;
receiving a notification of addition of the corresponding value to the account of the user from the transaction processor service.

18. The mobile device system of claim 17, wherein prior to the retrieving account value addition information, the operations further comprise:
communicating a request by the user to on-board for vendor deposits to the account of the user with the transaction processor service;
receiving a signup page from the microsite;
providing authentication credentials for the account to the microsite using the signup page, wherein the microsite on-boards the account of the user with the transaction processor service for the vendor deposits.

19. The mobile device system of claim 18, wherein in response to the transaction processor service on-boarding the account of the user for the vendors deposits, the transaction processor service retrieves the at least one price point option with the vendor and generates at least one selectable option within the account value addition interface using the at least one price point option.

20. The mobile device system of claim 17, wherein the operations further comprise:
displaying an available balance amount for the account to the user.
